(19) United States
(12) Patent Application Publication
(10) Pub. No.: US 2025/0319827 A1
(43) Pub. Date: Oct. 16, 2025

(54) AUTOMOTIVE SYSTEMS WITH LATTICED COMPONENTS

(71) Applicant: FORD GLOBAL TECHNOLOGIES, LLC, Dearborn, MI (US)

(72) Inventors: Keith WESTON, Canton, MI (US); David D. FRISKE, Wolverine Lake, MI (US); Michael Joseph NIKSA, Royal Oak, MI (US)

(21) Appl. No.: 18/632,898

(22) Filed: Apr. 11, 2024

(51) Int. Cl. B60R 13/02

(52) U.S. Cl. CPC B60R 13/02; B60R 2013/0287

(57) ABSTRACT

Automotive systems are presented. In one example, a cabin interior storage compartment includes a continuous latticed panel. The latticed panel has a portion defining a door for the cabin interior storage compartment and a living hinge portion defining a seam configured to permit rotation of the door about the seam for access to the cabin storage compartment. Other examples are also provided.

### TECHNICAL FIELD

This disclosure relates to automotive systems, particularly interior components used in automotive cabins.

### BACKGROUND

Additive manufacturing, commonly known as 3D printing, may offer flexibility in design and manufacturing. This technology stands out for its ability to create complex geometries and structures that are difficult to achieve with traditional manufacturing methods. In the automotive sector, additive manufacturing opens new avenues for innovation, particularly in the design and production of cabin comfort features.

Automotive original equipment manufacturers (OEMs) face challenges in integrating additive manufacturing techniques to cabin comfort features effectively. One concern is how to utilize these techniques to create innovative, customer-desirable features that are beneficial to the driving and passenger experience. This may include the development of customizable comfort features, where additive manufacturing is leveraged to produce components such as knee bolsters, console bolsters, and various forms of comfort and protection padding. Class A surfaces are intended to be aesthetically pleasing surfaces that match the vehicle's interior design while maintaining functionality. Producing steering wheel covers, armrest pads, console toppers, and other user-contact surfaces requires a balance between aesthetic appeal and functional performance.

### SUMMARY

An automotive system is presented. The automotive system comprises a cabin interior storage compartment including a continuous latticed panel. The latticed panel having a portion defining a door for the cabin interior storage compartment and a living hinge portion defining a seam configured to permit rotation of the door about the seam for access to the cabin storage compartment. The cabin interior storage compartment may further include a thermoplastic layer assembled on the latticed panel and configured to mate to a B surface of a vehicle. The portion defining the door may have a material with a durometer greater than the portion defining the seam. The continuous latticed panel may be a mesh, and the mesh may include interwoven strands.

Another embodiment of an automotive system is presented. The automotive trim system comprises a body defining a passageway therethrough and an exterior A surface, and a lattice cooperating with the body such that the lattice defines another exterior A surface contiguous with the exterior A surface and a terminal register for the passageway configured to permit exchange of air with the passageway. The lattice may be assembled with a thermoplastic layer configured to mate to a B surface of a vehicle. The body may have a material with a durometer greater than the lattice cooperating with the body. The lattice may be a mesh, and the mesh may have interwoven strands. A plurality of interwoven strands may be formed by printed material. In some embodiments the automotive system further comprises an environmental control system fluidly coupled to the passageway.

In another embodiment, the automotive system comprises an automotive trim component having a body defining an acoustic passageway therein and an exterior A surface, and a lattice cooperating with the body such that the lattice defines another exterior A surface contiguous with the exterior A surface and a structural acoustic matrix configured to direct sound from the acoustic passageway into a vehicle cabin.

The automotive trim components may further include a thermoplastic layer assembled on the lattice configured to mate to a B surface of a vehicle. A portion of the lattice that defines the structural acoustic matrix has a material with a durometer greater than the lattice that defines the A surface. The lattice may be a mesh. In some embodiments the mesh includes interwoven strands. Printed material may form the interwoven strands. In some embodiments, the acoustic passageway may be coupled to a vehicle air induction or other similar type of component.

### BRIEF DESCRIPTION OF THE DRAWINGS

FIGS. 1A and 1B are perspective views of an automotive system according to one embodiment;

FIG. 2 is a perspective view of an embodiment of the automotive system of FIGS. 1A and 1B;

FIG. 3 is a perspective view of an automotive system according to one embodiment;

FIG. 4 is a perspective view of an automotive system according to one embodiment;

FIG. 5 is a perspective view of an automotive system according to one embodiment; and

FIG. 6 is an exploded view of an automotive system according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure relates to additive manufacturing technologies in automotive design, to increase cabin comfort, functionality, and aesthetics. Additive manufacturing can create components that are tailored to specific user needs and are also integrated with features to elevate the overall driving experience.

In aspects of the disclosure the integration of functional elements such as handles, switches, lighting, and projector puddle lamps into additive manufactured parts is presented. The incorporation of these features into the vehicle's overall design contributes to the aesthetic appeal of the cabin interior.

In one aspect of the disclosure, the application of lattice structures and multi-material components is disclosed. These structured components possess mechanical properties such as shock absorption, thermal and acoustic insulation, and reduced weight. These properties allow for a high degree of customization and performance in various parts, including knee bolsters, console bolsters, and various forms of comfort and protection padding. The unique capabilities of additive manufacturing are leveraged to produce these complex geometries and material integrations, offering unprecedented levels of customization and innovation in automotive interior design.

In another aspect of the disclosure, lattice matrices for integrating handles within the automotive interior or cabin are disclosed. The application of lattice designs as a basis for embedding handles into various parts of the vehicle's cabin may simplify the manufacturing process while meeting design and functionality requirements.

In yet another aspect, the disclosure further explores the application of these structures in a vehicle's environmental or acoustic management systems coupled to the vehicle interior. By integrating lattice designs within automotive trim components, air flow management and sound direction to the vehicle cabin may also be integrated. This may increase the adjustability of the environmental control, making the cabin space more comfortable and adaptable to varying conditions, and may permit precision tuning of the acoustic experience, directing sound in a manner that enhances the auditory environment for passengers. The adaptability of the disclosed components additive manufacturing may allow for precise control over the lattice structure's density and composition, enabling the production of components tailored to specific functional requirements while maintaining aesthetic harmony with the vehicle's interior design.

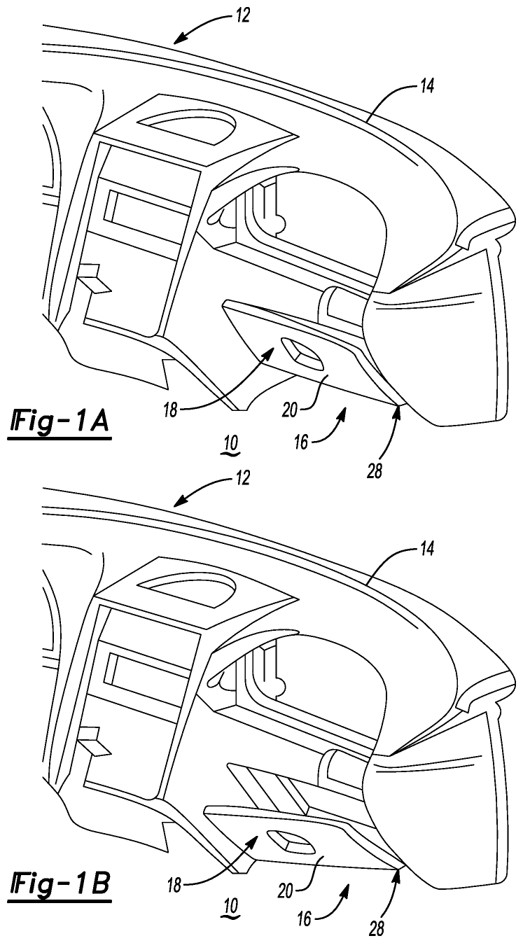

In FIGS. 1A and 1B, within a vehicle 10, a cabin interior 12 has instrument panel 14. The instrument panel 14 has an integrated cabin interior storage compartment 16 that features a continuous latticed panel 18. The panel 18 includes a portion that serves as a door 20 for the storage compartment 16. The door 20 is integrated using a living hinge portion 22 that defines a seam 24. This seam 24 allows the door 20 to rotate about it, providing access to the cabin storage compartment 16. The cabin storage compartment 16 is depicted as a glove box, however the continuous latticed panel 18 may be incorporated into any cabin storage compartment such as console storage, door pockets, under compartments, or overhead bins. The adaptability of the continuous latticed panel 18 to various storage needs within the vehicle's cabin 12, may reduce the complexity of assembly.

The latticed panel 18 is coupled with a thermoplastic layer 26. The thermoplastic layer 26 is assembled on the latticed structure 18 so that the interior storage compartment 16 may mate with the B surface 28 of the vehicle 10. The portion of the panel designated as the door 20 is constructed from a material with a durometer greater than that of the seam 24 defined by the living hinge 22. This variation in material hardness facilitates the operation of the door 20 and contributes to the durability of the storage compartment 16.

In the configuration shown, the latticed panel 18 is mesh 30. This mesh 30 is composed of interwoven strands 32-a structure that maintains the panel's overall integrity while allowing for a degree of flexibility in application. These strands 32 are formed from a plurality of printed materials 34, which may be deposited by any of various additive manufacturing techniques. The printed materials 34 may be made of any suitable material including plastics and thermoplastic polyurethanes (TPUs). Beyond TPUs, the materials may encompass Acrylonitrile Butadiene Styrene (ABS), Polycarbonate (PC), Polypropylene (PP), Polyamide (PA or Nylon), and Acrylic (PMMA). These materials can be deposited by various additive manufacturing techniques such as Fused Deposition Modeling (FDM) or Selective Laser Sintering (SLS).

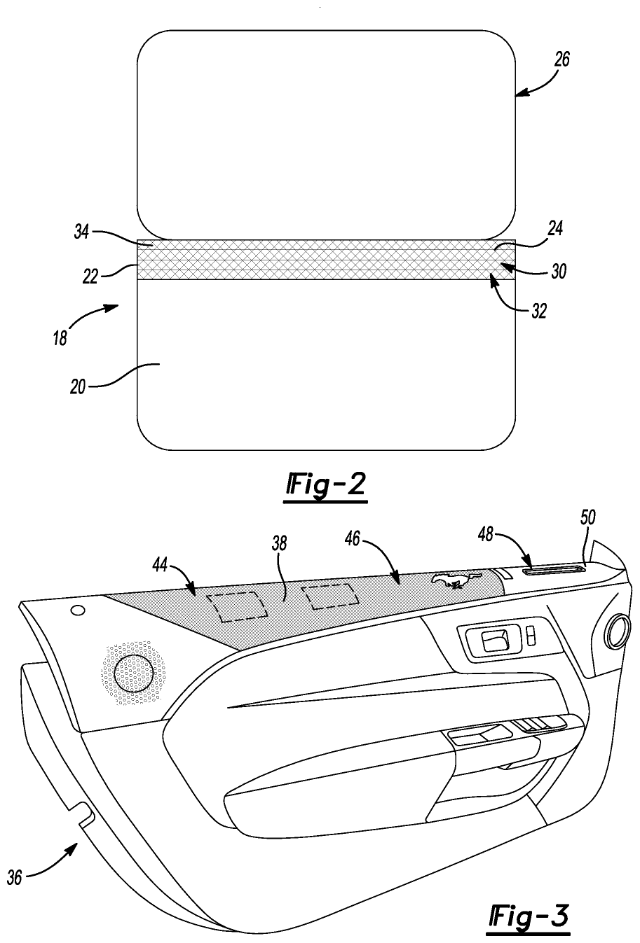

FIG. 2 is a perspective view of the latticed panel 18, with the door portion 20 and the living hinge portion 22 that establishes the seam 24. The mesh structure 30, comprised of interwoven strands 32, maintains the durability and flexibility of the panel 18.

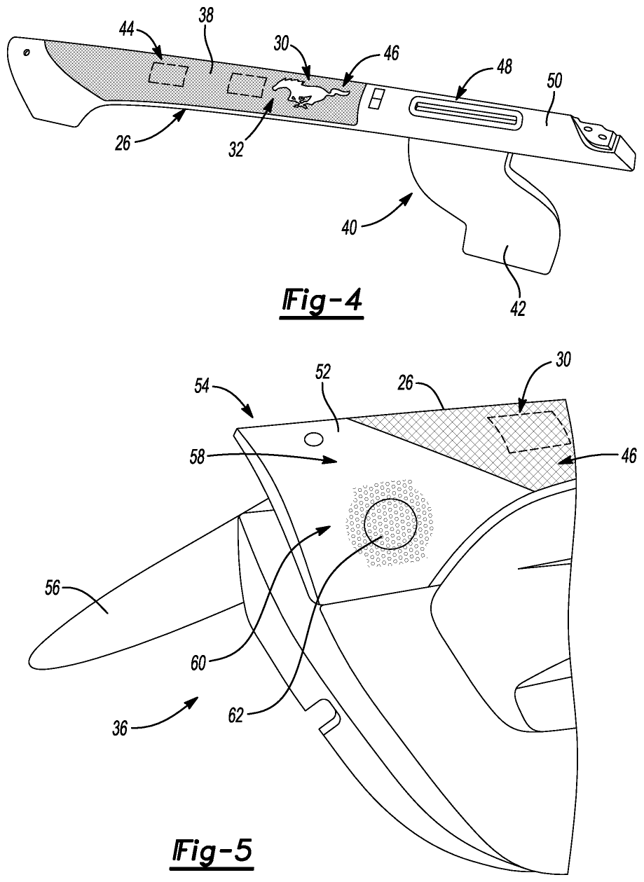

In FIGS. 3 and 4, an exterior door assembly 36 has an automotive trim component 38. The automotive trim component 38 has a body 40 that defines a passageway 42 therethrough and an exterior A surface 44. The exterior A surface 44, while part of the vehicle cabin interior 12, is external to the trim component 38. A lattice 46 cooperates with the body 40 to define another exterior A surface 48 aligning with the exterior surface 44. The exterior A surface 48 contiguous with the exterior A surface 44 defines a terminal register 50 for the passageway 42. This allows exchange of air with the passageway 42.

The lattice 46 may be the mesh 30 composed of interwoven strands 32. The mesh structure may be combined with a thermoplastic layer 26, for mating securely with the vehicle's B surface 28. For the body 40, materials with a higher durometer than those used for the lattice 46 are selected to enhance durability and structural integrity. Examples of materials that typically have a higher durometer for the body 40 compared to the lattice 46 include glass-filled nylon or polystyrene (HIPS) for the body, offering increased rigidity and resistance to physical deformation, whereas the lattice might utilize more flexible materials such as TPUs or ABS. The mesh 30 of the lattice 46 may be formed through utilization of additive manufacturing for the application of the interlocking strands 32. These strands 32 may be made from a range of printed materials 34, such as plastics and TPUs, ABS, PC, PP, PA, or Nylon, and PMMA. The use of these materials can be processed through methods such as FDM and SLS.

The passageway 42 may be fluidly coupled to an environmental control system within the vehicle 10. This connection allows for the modulation of air flow, directly influencing the cabin's climate and air quality. The tunability of the lattice 46 facilitates other embodiments, where registers 50 may be positioned in areas that are challenging to access. This tunability may enhance the efficiency of the environmental control system and allow for a more customizable approach to managing cabin conditions.

The customer-contacting surfaces on exterior A surface 44 of the automotive trim component 38 are customizable for stiffness by adjusting the contact geometry, such as by a softer surface texture or a layered lattice structure with variable stiffness across different areas. This adjustment may provide functional surface textures, such as those designed to stabilize the passenger's arm during dynamic events like off-road driving.

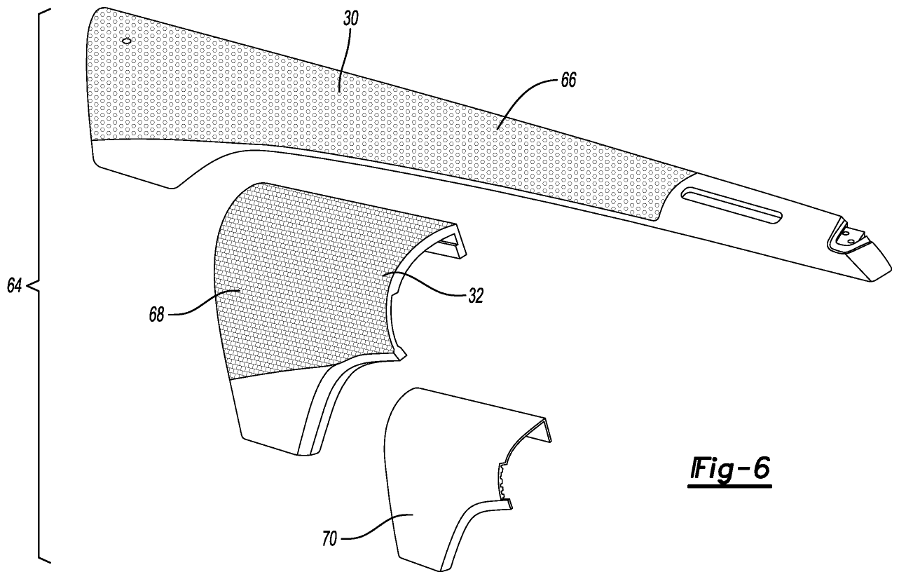

In FIG. 5 an exterior door assembly 36 has an automotive trim component 52. This trim component 52 has a body 54 that defines an acoustic passageway 56 contributing to the sound dynamics within the vehicle cabin 12, and an interior A surface 58 defining an interior surface of the cabin 12. The lattice 46 is integrated with the body 54 to form an additional exterior A surface 60 that is contiguous with the exterior A surface 56 to form part of a structural acoustic matrix 62 configured to direct sound from the acoustic passageway 56 to the cabin 12.

The mesh 30 within the lattice 46 contributes to the direction of sound through the acoustic passageway 42 into the cabin, to enhance the auditory environment for the vehicle's occupants. The mesh structure 30, composed of interwoven strands 32, is bonded with a thermoplastic layer 26 to maintain a secure attachment to the vehicle's B surface 28. Higher durometer materials are selected for the body 54 of the automotive trim component 52 compared to the lattice 46. The strands 32 of the lattice 46 may be formed via additive manufacturing from a variety of materials 34 including plastics, TPUs, ABS, PC, PP, PA, or Nylon, and PMMA, to offer flexibility in the design and function of the acoustic passageway 42. This flexibility allows for the modulation of sound within the vehicle's interior space. The acoustic passageway 42 may be acoustically coupled to the vehicle's environmental control system, a vehicle air induction or other similar type of component, or a traditional acoustic system. The tunability of the lattice 46 facilitates other embodiments, where the structural acoustic matrix 62 may be positioned in areas that are challenging to access. This tunability may increase the efficiency of the environmental control system and allow for a more customizable approach to managing cabin conditions. This matrix 62 may be positioned to optimize sound quality in areas that typically pose challenges for acoustic design, enhancing the auditory experience within the vehicle cabin 12. Precise placement can lead to increased performance of sound systems, contributing to the overall acoustical environment.

FIG. 6 is an exploded view of an automotive trim component 64 that may be used with any of the previous embodiments. It has a latticed top surface 66, a latticed mid layer 68, and a backside layer 70 for attachment. The top surface 64 and the mid layer 66 are made of differently tuned mesh 30 with interwoven strands 32. The top surface 64, visible to vehicle occupants, may feature a texture designed to secure a passenger's arm during dynamic driving conditions, such as off-roading. This variability in the lattices of layers allows for selective stiffening across the component, with denser areas of the lattice contributing to increased stiffness where needed.

The backside layer 68, may be made of a TPU for robust attachment to vehicle mating surfaces. The mesh 30, forming both the top surface 64 and the mid layer 66, enables the integration of graphics or tactile features for a user interface on the top surface 64, while the backside layer 66 maintains structural integrity. This multi-layer approach facilitates a cohesive system that provides tactile engagement, aesthetic appeal, and environment or acoustic management within the vehicle cabin.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive system comprising:
a cabin interior storage compartment including a continuous latticed panel having a portion defining a door for the cabin interior storage compartment and a living hinge portion defining a seam configured to permit rotation of the door about the seam for access to the cabin storage compartment.

2. The automotive system of claim 1 wherein the cabin interior storage compartment further includes a thermoplastic layer assembled on the latticed panel and configured to mate to a B surface of a vehicle.

3. The automotive system of claim 1 wherein the portion defining the door has a material with a durometer greater than the portion defining the seam.

4. The automotive system of claim 1 wherein the continuous latticed panel is a mesh.

5. The automotive system of claim 4 wherein the mesh includes interwoven strands.

6. The automotive system of claim 5 wherein printed material forms the interwoven strands.

7. An automotive system comprising:
an automotive trim component having a body defining a passageway therethrough and an exterior A surface, and a lattice cooperating with the body such that the lattice defines another exterior A surface contiguous with the exterior A surface and a terminal register for the passageway configured to permit exchange of air with the passageway.

8. The automotive system of claim 7 wherein the lattice is assembled with a thermoplastic layer configured to mate to a B surface of a vehicle.

9. The automotive system of claim 7 wherein the body has a material with a durometer greater than the lattice cooperating with the body.

10. The automotive system of claim 7 wherein the lattice is a mesh.

11. The automotive system of claim 10 wherein the mesh includes interwoven strands.

12. The automotive system of claim 11 wherein printed material forms the interwoven strands.

13. The automotive system of claim 7, further compromising an environmental control system fluidly coupled to the passageway.

14. An automotive system comprising:
an automotive trim component having a body defining an acoustic passageway therein and an exterior A surface, and a lattice cooperating with the body such that the lattice defines another exterior A surface contiguous with the exterior A surface and a structural acoustic matrix configured to direct sound from the acoustic passageway into a vehicle cabin.

15. The automotive system of claim 14 wherein the automotive trim component further includes a thermoplastic layer assembled on the lattice configured to mate to a B surface of a vehicle.

16. The automotive system of claim 14 wherein a portion of the lattice that defines the structural acoustic matrix has a material with a durometer greater than the lattice that defines the A surface.

17. The automotive system of claim 14 wherein the lattice is a mesh.

18. The automotive system of claim 17 wherein the mesh includes interwoven strands.

19. The automotive system of claim 18 wherein a plurality of printed material forms the interwoven strands.

20. The automotive system of claim 14 wherein the acoustic passageway is coupled to an air induction.
